(19) United States
(12) Patent Application Publication
(10) Pub. No.: US 2013/0132281 A1
(43) Pub. Date: May 23, 2013

(54) COMPUTER-IMPLEMENTED METHOD FOR CAPTURING DATA USING PROVIDED INSTRUCTIONS

(71) Applicants: Vilas L. Ankolekar, Pittsford, NY (US); Asheesh Srivastava, Pittsford, NY (US); Upanishad V. Mehta, Pittsford, NY (US)

(72) Inventors: Vilas L. Ankolekar, Pittsford, NY (US); Asheesh Srivastava, Pittsford, NY (US); Upanishad V. Mehta, Pittsford, NY (US)

(73) Assignee: Xerox Corporation, Norwalk, CT (US)

(21) Appl. No.: 13/302,246

(22) Filed: Nov. 22, 2011

(51) Int. Cl. G06Q 20/08

(52) U.S. Cl. 705/64; 705/39

(57) ABSTRACT

A computer-implemented method for capturing data including sending a set of select processing instructions for capture of a set of select data to a first party computer from an instruction provider computer; combining a set of non-select processing instructions for capture of a set of non-select data with the set of select processing instructions into a set of data requests, where the combining is performed by the first party computer; sending the set of data requests from the first party computer to an end user computer; processing the set of data requests on the end user computer according to the set of select processing instructions and the set of non-select processing instructions; sending the set of select data from the end user computer to a second party computer; and, sending the set of non-select data from the end user computer to the first party computer.

### TECHNICAL FIELD

The presently disclosed embodiments relate to providing a method for the capture of data using instructions provided by an instruction provider computer, and, more particularly, to a method for the capture of payment card data using instructions provided by an instruction provider computer that conform to established data security standards.

### BACKGROUND

The demand for methods to exchange data between computers using computer networks, including the Internet, is well known and constantly growing. Many individuals and businesses now use the Internet as both a shopping mall and a bank branch. Accordingly, some of the most visible ways in which data are exchanged between computers occur in the fields of commercial and financial transactions. However, given the sensitivity and potential for exploitation of the data exchanged in these transactions, particularly data like credit card numbers and bank account information, there is a great need to ensure the secure exchange and storage of these data.

Many methods have been developed that attempt to reduce the risk of data capture by unauthorized third parties. Methods like data encryption protect data during the exchange between two computers. However, even after data has been exchanged, it still must be protected from capture by unauthorized third parties.

In order to protect data after they have been exchanged, various systems have been created that establish data safeguarding procedures. For example, The Payment Card Industry Data Security Standard (PCI DSS) was created by the PCI Security Standards Council to help the organizations that process card payments prevent payment card fraud. PCI DSS strengthens data security by establishing control and auditing procedures for the handling of payment card data, thereby limiting data capture and security breaches by unauthorized third parties. All organizations that store, process, or send cardholder information from any type of payment card must be compliant with the PCI DSS standard. As a result of the increased security, payment companies give preferred rates and other incentives to organizations that are PCI DSS compliant. These benefits can save PCI DSS compliant organizations millions of dollars every year. Also, as an added benefit, organizations are less likely to suffer security breaches due to tighter control over sensitive data. This can have positive effect for compliant organizations through increased customer confidence, and thus, sales revenue.

As PCI DSS is a complex and strict standard, it can be prohibitively expensive for some organizations to make their existing data storage and processing systems compliant with PCI DSS. However, there are many ways an organization can become PCI DSS compliant. One of the more popular solutions, particularly for smaller organizations, is to outsource the payment card data storage and processing to an External Payment Card Service Provider (EPCSP). In this solution, only the EPCSP needs to be PCI DSS compliant, not the original organization.

However, due to the risk of data capture by unauthorized third parties, individuals and businesses have become protective of their data, sometimes refraining from purchasing from vendors that do not appear to have robust payment card data security systems in place. One indicator of such a lack of security is the need for another party to process the actual purchase transaction on behalf of the vendor. This transfer to the payment processor, although it may be to a PCI DSS compliant EPCSP, reduces consumer confidence in the vendor.

Thus, there is a need for a method to process and store sensitive data that allows an organization to outsource such processing and storing to a security standard-compliant organization, but one which also does not reveal such outsourcing to the consumer, thereby preserving consumer confidence in the organization.

### SUMMARY

Broadly, the methods discussed infra relate to providing a method for the capture of data using instructions provided by an instruction provider computer. A typical data capture scenario not using the method provided by the presently disclosed embodiments may include the sending of payment card information as part of an online purchase transaction. In this case, for example, a vendor computer sends a set of data requests to a customer computer that are processed by a web application executed in a web browser and displayed as part of a web page viewable by the end user. These data requests may be displayed as text fields into which the end user can type the requested information. Following the input of information, the end user initiates transmission of the information, and the data requests are processed by the web application such that the information is sent directly to the vendor computer. More generally, the vendor computer sends instructions to the end user computer that the payment card information should be sent directly to the vendor's computer, and transmission by the end user computer is carried out in accordance with these instructions.

Alternatively, the vendor computer may send instructions to the end user computer that directs the web application to connect to an EPCSP computer, at which point the end user can enter the required payment card information and send such information using the interface provided by the EPCSP computer, namely a web page. Following receipt of the payment card information, the EPCSP computer would send a token, namely an encapsulated representation of the payment card information, to the vendor computer. Receipt of this token would indicate to the vendor that the end user provided valid payment card information. At this point, the remainder of the transaction between the vendor and the end user could continue.

By not processing the payment card information on the vendor computer, and only receiving an encapsulated representation of the payment card information, the vendor does not need to be compliant with any applicable security standards. However, this method of displaying the EPCSP-specific interface on the end user computer may be undesirable to the end user, as it reveals a disconnect between the end user and the vendor and introduces an unexpected third party to which the end user is expected to trust sensitive information.

According to aspects illustrated herein, there is provided a computer-implemented method for capturing data including sending a set of select processing instructions for capture of a set of select data to a first party computer from an instruction provider computer; combining a set of non-select processing instructions for capture of a set of non-select data with the set of select processing instructions into a set of data requests, where the combining is performed by the first party computer; sending the set of data requests from the first party computer to an end user computer; processing the set of data requests on the end user computer according to the set of select processing instructions and the set of non-select processing instructions; sending the set of select data from the end user computer to a second party computer; and, sending the set of non-select data from the end user computer to the first party computer.

According to other aspects illustrated herein, there is provided a computer-implemented method for capturing payment card data comprising sending a set of payment card processing instructions for capture of a set of payment card data to a vendor computer from an instruction provider computer; combining a set of non-sensitive processing instructions for capture of a set of non-sensitive data with the set of payment card processing instructions into a set of data requests, where the combining is performed by the vendor computer; sending the set of data requests from the vendor computer to a customer computer; processing the set of data requests on the customer computer according to the set of payment card processing instructions and the set of non-sensitive processing instructions; sending the set of payment card data from the customer computer to an external payment card service provider computer; and, sending the set of non-sensitive data from the customer computer to the vendor computer.

According to further aspects illustrated herein, there is provided a computer-implemented method for capturing payment card data comprising combining a set of non-sensitive processing instructions for capture of a set of non-sensitive data with a set of payment card processing instructions into a set of data requests, where the combining is performed by a vendor computer; sending the set of data requests from the vendor computer to a customer computer; and, receiving a set of non-sensitive data on the vendor computer from the customer computer.

According to additional aspects illustrated herein, there is provided a computer-implemented method for capturing payment card data comprising receiving a set of data requests comprising a set of payment card processing instructions and a set of non-sensitive processing instructions on a customer computer; processing the set of data requests on the customer computer according to the set of payment card processing instructions and the set of non-sensitive processing instructions; sending the set of payment card data from the customer computer to an external payment card service provider computer; and, sending the set of non-sensitive data from the customer computer to a vendor computer.

According to still other aspects illustrated herein, there is provided a computer-implemented method for capturing payment card data comprising sending a set of payment card processing instructions for capture of a set of payment card data to a vendor computer from an instruction provider computer, where the set of payment card processing instructions are combined with a set of non-sensitive processing instructions on the vendor computer to create a set of data requests that are subsequently processed by a customer computer.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a schematic illustration of the data capture arrangement of a representative embodiment;

FIG. 2 is a schematic illustration of the processing instruction and data request path of a representative embodiment;

FIG. 3 is an illustration of a computer monitor displaying a combination of select data and non-select data in a representative embodiment;

FIG. 4 is a flowchart detailing the individual steps in a representative embodiment; and,

FIG. 5 is a flowchart detailing the individual steps in an alternate embodiment.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “computer network” or “networked computers” are intended generally to refer to a collection of computing devices (e.g., personal computers, servers, portable computers, etc.) arranged and connected through a network, such as a local area network or the Internet. Over such “computer networks,” data and instructions can be sent and received by the component computing devices. By “computer,” “personal computer,” or “computing device” it is generally meant any analog or digital electronic device which includes a processor, memory, and/or a storage medium for operating or executing software or computer code. By “payment card” it is meant any type of card, device, or abstraction used to authorize payment from an account that is used to hold the funds of the owner of the “payment card.” “Payment cards” comprise credit cards, debit cards, charge cards, and the like. The data used to authorize a payment transaction can be encoded as text written on the card, stored in a magnetic strip, stored digitally in an integrated circuit or similar apparatus, memorized by the owner of the card, or any combination of these or equivalent methods. By “non-sensitive data” it is generally meant the pieces of data that cannot, alone or in combination with other “non-sensitive data,” be used to authorize a payment transaction or other transaction. These pieces of data may comprise the name, address, and phone number of the owner of a payment card, as well as other pieces of information that do not identify an owner of a payment card, such as coupon codes or the like. By “sensitive data” it is generally meant the specific pieces of data that are needed to authorize a payment transaction or other secure transaction. These pieces of data may comprise credit card numbers, credit card expiration dates, and card verification numbers. Data that otherwise may be considered “non-sensitive data,” such as the name and address of the owner of the card, can be considered “sensitive data” if, when combined with other pieces of data, such as a credit card number, they are needed to authorize a payment transaction. As used herein, “encapsulated” refers to the state of data which has been summarized, truncated, encrypted, or otherwise transformed into a representation of its original form. “Encapsulated” data can be used to indicate to a party that the original data is accurate or if the data has been used to authorize a transaction successfully without providing the original data in full.

Moreover, although any methods, devices or materials similar or equivalent to those described herein can be used in the practice or testing of these embodiments, some embodiments of methods, devices, and materials are now described.

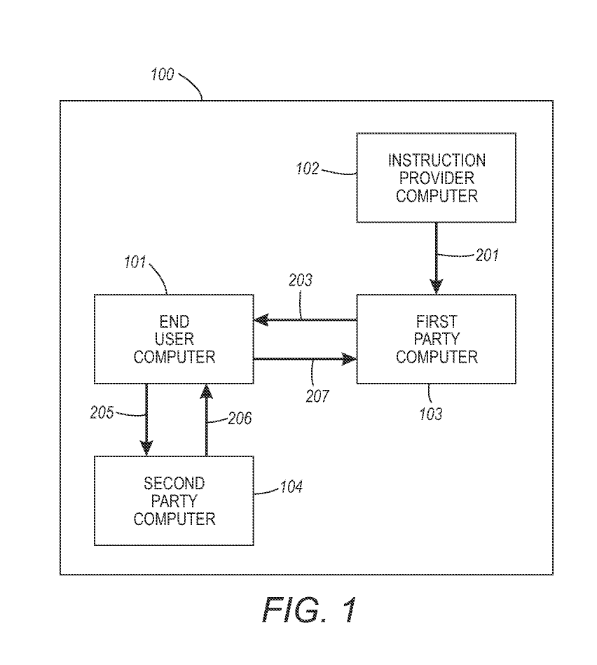

Referring now to the figures, FIG. 1 shows an arrangement of networked computers 100 comprising end user computer 101, instruction provider computer 102, first party computer 103, and second party computer 104. It should be appreciated that due to the nature of computers and network computer resources, FIG. 1 schematically represents a variety of arrangements, depending on what is referred to by each reference numeral. That is, end user computer 101, instruction provider computer 102, first party computer 103, and second party computer 104 each could be an individual computer or each could comprise a data center or a collection of interconnected computers.

The computers described in the arrangement of networked computers 100, namely, end user computer 101, instruction provider computer 102, first party computer 103, and second party computer 104, exchange data processing instructions and data over a computer network, such as the Internet, in a series of transactions: sending of a set of select processing instructions 201 from the instruction provider computer 102 to the first party computer 103; sending of a set of data requests 203 from the first party computer 103 to the end user computer 101; sending of a set of select data 205 from the end user computer 101 to the second party computer 104; sending of a token 206 from the second party computer 104 to the end user computer 101; and, sending of a set of non-select data and the token 207 from the end user computer 101 to the first party computer 103.

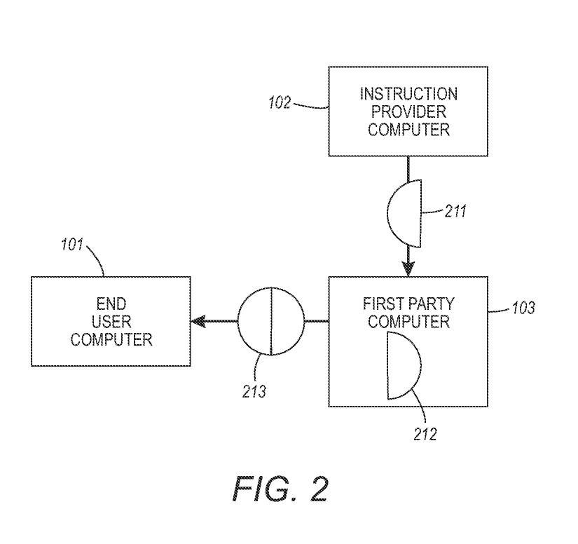

FIG. 2 shows a more detailed view of instruction provider computer 102, first party computer 103, and end user computer 101 and the processing instructions exchanged between said computers. A set of select processing instructions 211 is stored on instruction provider computer 102. The instructions comprising the set of select processing instructions 211 describe how certain pieces of sensitive data, such as credit card numbers, credit card expiration dates, and credit card security codes, should be processed on a computer and transmitted to other computers. The set of select processing instructions 211 may, in a preferred embodiment, process and transmit these types of sensitive data in compliance with the PCI DSS security standard, discussed supra. One way in which the set of select processing instructions 211 may conform to the PCI DSS security standard is by instructing end user computer 101 to send sensitive data only to a second party computer 104 that belongs to a PCI DSS compliant entity, e.g. an EPCSP, discussed supra, instead of first sending data to an entity that may not be PCI DSS compliant, and may only need non-sensitive data, such as first party computer 103.

The set of select processing instructions 211 is sent by the instruction provider computer 102 to the first party computer 103 as part of the sending of the set of select processing instructions 201. Upon receipt by the first party computer 103, the set of select processing instructions 211 is either stored on the first party computer 103 for use at a later time or it is used immediately by combining the set of select processing instructions 211 with a set of non-select processing instructions 212 to create a set of data requests 213. It should be appreciated, that given the nature of digitally stored information, the set of select processing instructions 211 can be combined with the set of non-select processing instructions 212 an arbitrary number of times, i.e., the set of select processing instructions is not depleted through repeated combination. The instructions comprising the set of non-select processing instructions 212 describe how certain pieces of non-sensitive data, such as an individual's name, shipping address, or coupon codes, should be processed on a computer and sent to other computers. The set of data requests 213, in turn, comprises the set of select processing instructions 211 and the set of non-select processing instructions 212. In a preferred embodiment, the set of data requests 213 is incorporated into a web application that is sent to end user computer 101 and executed in a web browser which is executed on end user computer 101. Any known web development methods may be used in the creation of such a web application, including AJAX.

The purpose of the set of select processing instructions 211 is to provide instructions to the first party computer 103 regarding the format and transmission instructions for data sent to the second party computer 104 by the end user computer 101. As instruction provider computer 102 sends the set of select processing instructions 211 to first party computer 103 as part of the set of data requests 213, first party computer 103 does not need to promulgate these instructions, keep them up to date, or ensure their compliance with any applicable security standards, such as PCI DSS. This also serves to remove the responsibility and liability that the entity operating first party computer 103 would normally have in maintaining compliance with such security standards.

In a preferred embodiment, the set of select processing instructions 211 comprises information about the payment card data elements that need to be displayed and captured from the purchaser in an electronic commerce transaction, as well as information about the EPCSP location, mode, and method of data transmission, including any secured credentials or protocols.

In another preferred embodiment, the set of select processing instructions 211 are sent to first party computer 103 in the standard format and protocol expected by first party computer 103. The instructions comprising the set of select processing instructions 211 may also describe how non-sensitive data, such as an individual's name or billing address, should be processed, if such data are needed as part of the authentication or authorization performed by the second party computer 104 as part of the payment card processing. However, it should be appreciated that, given the proprietary nature of EPCSPs, the set of select processing instructions 211 may include multiple sets of secured credentials and protocols to accommodate the requirements of different EPCSPs.

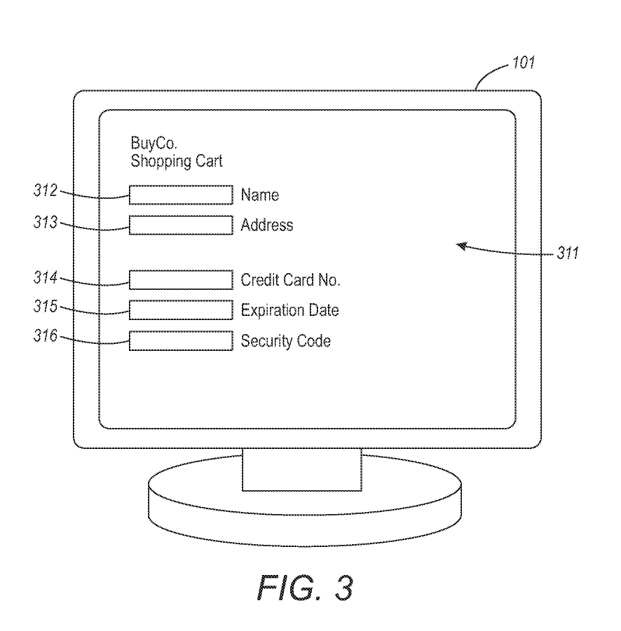

FIG. 3 shows a representative embodiment, wherein certain information would appear on a computer monitor to a user of end user computer 101. A web browser 311 is run on end user computer 101 and is directed to connect to first party computer 103, which functions as a web server. As part of a commercial transaction, web browser 311 is directed to the web page shown in FIG. 3. At the end of this transaction, a “check out” page is displayed. This “check out” page is a web application that comprises, in part, the set of data requests 213. The web application processes the data requests, separating the set of data requests 213 into the individual processing instructions that comprise the set of select processing instructions 211 and the set of non-select processing instructions 212. The web application also displays a web page which contains text fields 312, 313, 314, 315, and 316 into which the user is prompted by descriptive text or other means to input requested information. The descriptive text corresponding to text fields 312 and 313 prompts the user to input a name and address, respectively, and the descriptive text corresponding to text fields 314, 315, and 316 prompts the user to input a credit card number, a credit card expiration date, and a credit card security code, such as the common Card Verification Value (CVV), respectively. In this embodiment, the information input into text fields 312 and 313 comprises information processed according to the set of non-select processing instructions 212 and the information input into text fields 314, 315, and 316 comprises information processed according to the set of select processing instructions 211.

Upon inputting the requested information into text fields 312, 313, 314, 315, and 316, the user initiates the execution of the processing instructions that comprise the set of data requests 213 by pressing a “submit” button or similar means. In this embodiment, the information input into text fields 314, 315, and 316 is sent, in compliance with any applicable security standards or data formats described in the set of select processing instructions 211, to second party computer 104 as part of the sending of the set of select data 205. From the perspective of the user of end user computer 101, the sending of the set of select data 205 occurs from a web page hosted by the entity that operates the first party computer 103. The method of the presently disclosed embodiments therefore hide the sending of the set of select data 205 to second party computer 104 and eliminates the need for the end user computer 101 to connect to a separate web application offered by second party computer 104. This greatly enhances the experience of the user of the end user computer 101 by maintaining a consistent look and feel throughout the transaction with first party computer 103. Furthermore, as a consistent look and feel is maintained throughout the transaction, the risk of a “phishing attack,” where a malicious third party poses as a legitimate entity to capture sensitive data, such as payment card data, is reduced.

Upon receipt of the data sent as part of the sending of the set of select data 205, second party computer 104 uses said data for authentication or authorization purposes. In one embodiment, the second party computer 104 is operated by an EPCSP, which uses the received data to authorize a payment card transaction. In another embodiment, the second party computer 104 is operated by a bank, which uses the received data to authenticate a user as the owner of an account with said bank. It should be appreciated that the means by which an entity that operates the second party computer 104 uses the received data for authentication or authorization purposes varies considerably due to the wide variety of roles of these entities perform and due to security standards, such as PCI DSS, that dictate how data must be processed and stored.

In one embodiment, second party computer 104, after receiving the set of select data sent as part of the sending of the set of select data 205 and using said data for authentication or authorization purposes, sends a token representation of said data to end user computer 101 as part of the sending of a token 206. This token is an encapsulated representation of the select data sent as part of the sending of the set of select data 205. The token may comprise said select data in an encrypted form or a truncated form, such as including only the last 4 digits of a credit card number, such that the select data cannot be used for its original purpose. Those having ordinary skill in the art will recognize that many methods are available to obfuscate or symbolize the select data. Regardless of the method used to generate the token, it does not comprise the original select data in an accessible or usable form. The token does not serve as a container to store or transmit said select data, but rather as an indicator that second party computer 104 has received said select information and successfully processed said select information in relation to the specific transaction. If the authentication or authorization fails for any reason, e.g., the set of select data does not correspond to any known payment card account, the token instead serves as an indicator that the authentication or authorization process has failed.

Upon receipt of the token by end user computer 101, the web application running on end user computer 101 sends the non-select data and the token to first party computer 103 as part of the sending of the set of non-select data and the token 207. First party computer 103 uses the non-select data to complete the original transaction and uses the token to verify that the select data send by end user computer 101 to second party computer 104 was properly authenticated by second party computer 104. As the token does not contain any of the select data in a useable form, first party computer 103 is able to perform this verification without receiving or storing any of the select data, which removes the need for the first party computer 103 to comply with any applicable security standards, such as PCI DSS.

In an alternate embodiment, upon receipt of the token by end user computer 101, the web application running on end user computer 101 sends the token to instruction provider computer 102. End user computer 101 then sends the non-select data to first party computer 103. After receipt of the token from end user computer 101, instruction provider computer 102 sends the token to first party computer 103. First party computer 103 uses the non-select data to complete the original transaction and uses the token to verify that the select data sent by end user computer 101 to second party computer 104 was properly authenticated by second party computer 104. Again, as the token does not contain any of the select data in a useable form, first party computer 103 is able to perform this verification without receiving or storing any of the select data, which removes the need for the first party computer 103 to comply with any applicable security standards, such as PCI DSS.

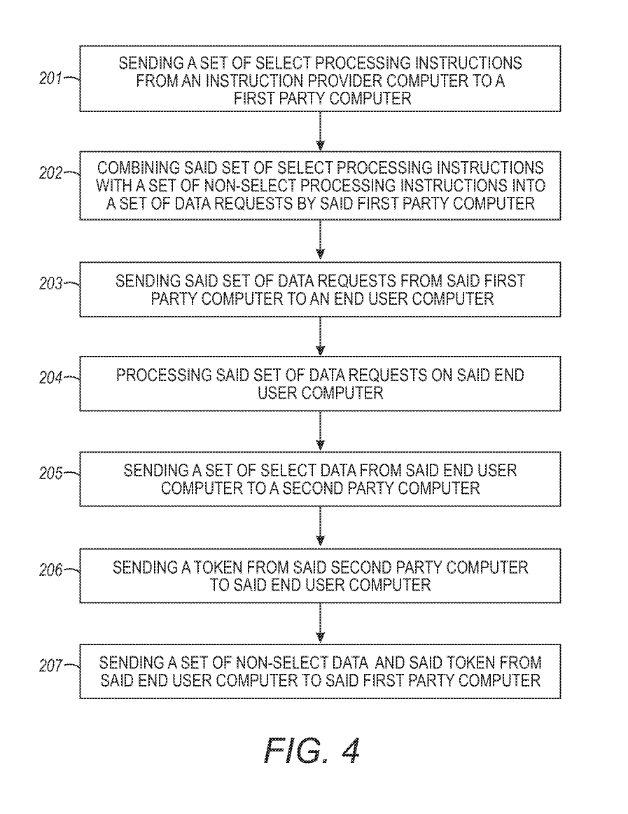

FIG. 4 shows a flowchart detailing the individual steps in a representative embodiment. The sending of a set of select processing instructions 201 from the instruction provider computer 102 to the first party computer 103 provides the first party computer 103 with a set of select processing instructions 211. First party computer 103 thereafter effects a combining of the set of select processing instructions with a set of non-select processing instructions into a set of data requests 202. In response to a transaction initiated by end user computer 101 and requiring both select and non-select data, first party computer 103 effects a sending of a set of data requests 203 from the first party computer 103 to the end user computer 101 to be processed by the web application running on end user computer 101. A processing of the data requests on the end user computer 204 directs end user computer 101 to prompt for select and non-select data and describes the respective destinations and manner by which the select and non-select data should be processed and sent. After the information requested by the set of data requests 213 has been input into end user computer 101, the data processing portions of the set of data requests 213 are executed, initiating a sending of a set of select data 205 from the end user computer 101 to the second party computer 104. The select data is received by second party computer 104 and used to authenticate or authorize a portion of the transaction previously initiated between end user computer 101 and first party computer 103. After second party computer 104 completes the authentication or authorization processing, second party computer 104 effects a sending of a token 206 from the second party computer 104 to the end user computer 101. Upon receipt of this token by the web application running on end user computer 101, end user computer 101 effects a sending of the set of non-select data and the token 207 from the end user computer 101 to the first party computer 103. First party computer 103 then uses the non-select data to complete the original transaction and the token to verify that the select data sent by end user computer 101 to second party computer 104 was properly authenticated by second party computer 104.

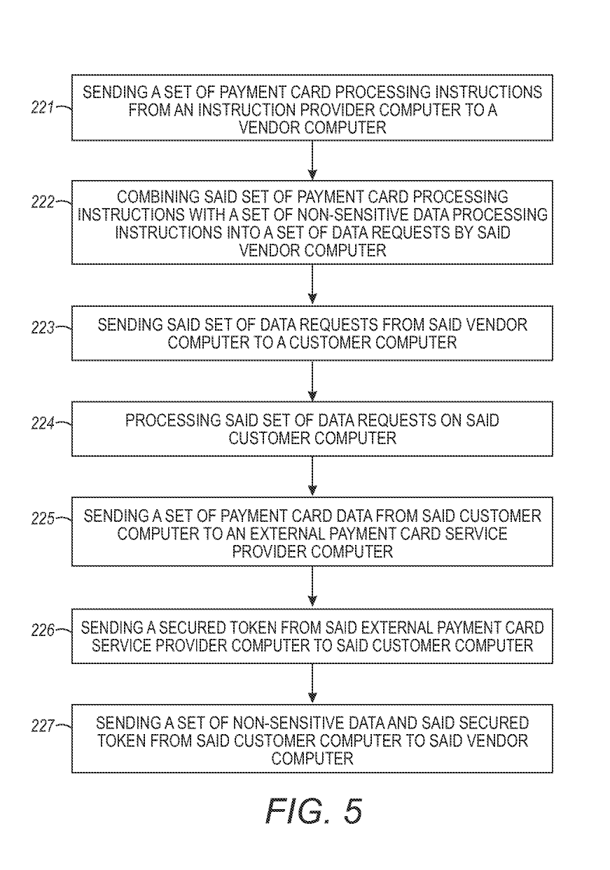

FIG. 5 shows a flowchart detailing the individual steps in another representative embodiment, namely an embodiment used to capture payment card data in an online purchase transaction. The sending of a set of payment card processing instructions 221, which is analogous to the sending of a set of select processing instructions 201, from an instruction provider computer, which is analogous to the instruction provider computer 102, to a vendor computer, which is analogous to the first party computer 103, provides the vendor computer with a set of payment card processing instructions, which is analogous to the set of select processing instructions 211. The vendor computer thereafter effects a combining of the set of payment card processing instructions with a set of non-sensitive data processing instructions, which is analogous to the set of non-select processing instructions 212, into a set of data requests 222, which is analogous to the combining of the set of select processing instructions with a set of non-select processing instructions into a set of data requests 202. In response to an online purchase transaction initiated by a customer computer, which is analogous to end user computer 101, and requiring both payment card and non-sensitive data, the vendor computer effects a sending of a set of data requests 223, which is analogous to the sending of a set of data requests 203, from the vendor computer to the customer computer to be processed by the web application running on the customer computer. A processing of the data requests on the customer computer 224, which is analogous to the processing of the data requests on the end user computer 204, directs the customer computer to prompt for payment card and non-sensitive data, such as the customer name and address, and describes the respective destinations and manner by which the payment card and non-sensitive data should be processed and sent. After the information requested by the set of data requests has been input into the customer computer, the data processing portions of the set of data requests are executed, initiating a sending of a set of payment card data 225, which is analogous to the sending of a set of select data 205, from the customer computer to an external payment card service provider computer, which is analogous to the second party computer 104. The payment card data is received by the external payment card service provider computer and used to verify that the payment card information provided by the customer computer corresponds to a valid payment card with sufficient available funds to carry out the online purchase transaction. Depending on the type of payment card used in the online purchase transaction, the external payment card service provider computer will send the payment card data to the issuing bank or payment card provider so the account can be properly debited. After the external payment card service provider computer completes this verification, it effects a sending of a secured token 226, which is analogous to the sending of a token 206, from the external payment card service provider computer to the customer computer. Upon receipt of this secured token by the web application running on the customer computer, the customer computer effects a sending of the set of non-sensitive data and the secured token 227, which is analogous to the sending of the set of non-select data and the token 207, from the customer computer to the vendor computer. The vendor computer then uses the non-sensitive data to complete the online purchase transaction and the secured token to verify that the payment card data send by the customer computer to the external payment card service provider computer corresponds to a valid payment card with sufficient available funds to carry out the online purchase transaction.

It should be appreciated that the embodiments disclosed above provide benefits to vendor entities that are not compliant with security standards, such as PCI DSS, by allowing them to integrate the capture of data that typically requires adherence to such standards, e.g., payment card data, with the capture of non-select data, e.g., name and address, into a single web application, instead of redirecting end users or customers to a security standards-compliant entity, such as an EPCSP. This integration allows the look and feel of an online purchase transaction to be consistent to the end user or customer, thereby increasing end user or customer confidence in the vendor entity. As this integration prevents the end user or customer from having to navigate away from the vendor entity's website, it also reduces the possibility of “phishing attacks,” discussed supra.

The embodiments disclosed above provide additional benefits to vendor entities by eliminating the need for said entities to process and store sensitive data, such as payment card data, internally. This reduces the risk of exposure of such sensitive data through accidents or intentional intrusions into vendor entity computers by malicious third-party entities looking to steal such sensitive data. The embodiments disclosed above provide further benefits by eliminating the need for vendor-entities to understand and comply with the data format and handling requirements set forth by individual security standards-compliant entities, such as EPCSPs. This reduces the costs associated with establishing such compliance and this provides vendor entities with increased freedom to choose from among the available security standards-compliant entities.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method for capturing payment card data comprising:
(a) sending a set of payment card processing instructions for capture of a set of payment card data to a vendor computer from an instruction provider computer;
(b) combining a set of non-sensitive processing instructions for capture of a set of non-sensitive data with said set of payment card processing instructions into a set of data requests, where said combining is performed by said vendor computer;
(c) sending said set of data requests from said vendor computer to a customer computer;
(d) processing said set of data requests on said customer computer according to said set of payment card processing instructions and said set of non-sensitive processing instructions;
(e) sending said set of payment card data from said customer computer to an external payment card service provider computer; and,
(f) sending said set of non-sensitive data from said customer computer to said vendor computer.

2. The method recited in claim 1 further comprising sending a secured token from said external payment card service provider computer to said customer computer no earlier than the completion of step (e).

3. The method recited in claim 2 wherein said secured token comprises an encapsulated representation of said set of payment card data.

4. The method recited in claim 2 wherein said secured token is sent to said vendor computer from said customer computer.

5. The method recited in claim 2 wherein said secured token and said set of non-sensitive data are combined and sent contemporaneously to said vendor computer from said customer computer.

6. The method recited in claim 2 further comprising sending of said secured token to said instruction provider computer from said customer computer.

7. The method recited in claim 6 further comprising sending of said secured token to said vendor computer from said instruction provider computer.

8. The method recited in claim 1 wherein said external payment card service provider computer is compliant with the PCI DSS security standard.

9. The method recited in claim 1 wherein step (e) is performed in accordance with the PCI DSS security standard.

10. A computer-implemented method for capturing payment card data comprising:
(a) combining a set of non-sensitive processing instructions for capture of a set of non-sensitive data with a set of payment card processing instructions into a set of data requests, where said combining is performed by a vendor computer;
(b) sending said set of data requests from said vendor computer to a customer computer; and,
(c) receiving a set of non-sensitive data on said vendor computer from said customer computer.

11. The method recited in claim 10 wherein said set of payment card processing instructions is provided to said vendor computer by an instruction provider computer.

12. The method recited in claim 10 further comprising receiving a secured token on said vendor computer from said customer computer.

13. The method recited in claim 10 further comprising receiving a secured token on said vendor computer from an instruction provider computer.

14. A computer-implemented method for capturing payment card data comprising:
(a) receiving a set of data requests comprising a set of payment card processing instructions and a set of non-sensitive processing instructions on a customer computer;
(b) processing said set of data requests on said customer computer according to said set of payment card processing instructions and said set of non-sensitive processing instructions;
(c) sending said set of payment card data from said customer computer to an external payment card service provider computer; and,
(d) sending said set of non-sensitive data from said customer computer to a vendor computer.

15. The method recited in claim 14 wherein said set of data requests is sent to said customer computer from said vendor computer.

16. The method recited in claim 14 further comprising receiving a secured token on said customer computer from said external payment card service provider computer no earlier than the completion of step (c).

17. The method recited in claim 16 further comprising sending said secured token from said customer computer to said vendor computer.

18. The method recited in claim 16 further comprising sending said secured token from said customer computer to an instruction provider computer.

19. A computer-implemented method for capturing payment card data comprising sending a set of payment card processing instructions for capture of a set of payment card data to a vendor computer from an instruction provider computer, where said set of payment card processing instructions are combined with a set of non-sensitive processing instructions on said vendor computer to create a set of data requests that are subsequently processed by a customer computer.

20. A computer-implemented method for capturing data comprising:
(a) sending a set of select processing instructions for capture of a set of select data to a first party computer from an instruction provider computer;
(b) combining a set of non-select processing instructions for capture of a set of non-select data with said set of select processing instructions into a set of data requests, where said combining is performed by said first party computer;
(c) sending said set of data requests from said first party computer to an end user computer;
(d) processing said set of data requests on said end user computer according to said set of select processing instructions and said set of non-select processing instructions;
(e) sending said set of select data from said end user computer to a second party computer; and,
(f) sending said set of non-select data from said end user computer to said first party computer.
